(19) United States
(12) Patent Application Publication
(10) Pub. No.: US 2026/0370159 A1
(43) Pub. Date: Nov. 19, 2026

(54) ROTARY ACTUATOR USING ELECTROSTATIC ZIPPING AND DRIVING METHOD THEREOF

(71) Applicant: KOREA ADVANCED INSTITUTE OF SCIENCE AND TECHNOLOGY, Daejeon (KR)

(72) Inventors: Ki-Uk KYUNG, Daejeon (KR); Hyunwoo KIM, Daejeon (KR)

(73) Assignee: KOREA ADVANCED INSTITUTE OF SCIENCE AND TECHNOLOGY, Daejeon (KR)

(21) Appl. No.: 19/679,995

(22) Filed: May 18, 2026

(30) Foreign Application Priority Data
May 16, 2025 (KR) 10-2025-0063639
May 13, 2026 (KR) 10-2026-0086812

(51) Int. Cl. H02N 1/00; H02N 2/12; H02N 2/14

(52) U.S. Cl. CPC H02N 1/006; H02N 2/12; H02N 2/14

(57) ABSTRACT

Provided are a rotary actuator using electrostatic zipping and a driving method of the rotary actuator. The rotary actuator includes a rotor, a stator, and a strip having an end connected to the rotor and zipped along an inner surface of the stator. In a zipping zone between the strip and the stator, a first electrode, a second electrode, an electroactive polymer film, and a dielectric fluid may be arranged.

### TECHNICAL FIELD

The disclosure relates to a rotary actuator. This study has been carried out under the Samsung Future Technology Development Project (Task Number: SRFC-IT2102-04).

### BACKGROUND ART

General rotary actuators often have motor structures using an electromagnetic force. These electromagnetic rotary actuators include coils, magnets, and magnetic materials, and generate a rotational force through interaction between electric current and magnetic fields.

However, because electromagnetic actuators use magnetic materials or magnetic fields, their use may be limited in magnetic field sensitive environments. For example, in high-magnetic-field environments, such as magnetic resonance imaging (MRI) systems, it is difficult to use electromagnetic actuators, or the actuators may affect image quality. The electromagnetic actuators may have issues such as heat generation due to current flow, limitations on miniaturization, and structural complexity. Consequently, the use of electromagnetic motors may be restricted in environments sensitive to magnetic fields, for example, MRI systems or in high-magnetic-field environments.

Actuators using an electrostatic force may be driven with relatively low current, and may be manufactured using non-magnetic materials, thus being favorable to high-magnetic-field environments. However, when an electrostatic zipping mechanism of the related art is used, once a strip is adhered to an inner surface of a stator, a corresponding area may be brought to the same electrical potential or placed in an electrically shielded state, making it difficult to apply additional zipping.

### PRIOR ART

### Patent Document

(Patent Document 1) WO2019002860A1

### DISCLOSURE OF INVENTION

### Technical Problem to be Solved

Provided is a rotary actuator capable of converting electrostatic zipping motion into rotational torque by using a rotor, a stator, and a strip.

Provided is an electrostatic zipping rotary actuator capable of amplifying rotational torque by using a plurality of strips.

Provided is a range of motion (ROM) scaling strip structure capable of preventing an issue in which an allowable zipping angle of each strip is limited inversely proportional to the number of strips in a structure of a plurality of strips.

Provided are a rotary actuator and a driving method thereof in which an electrical boundary condition of a strip is sequentially reconfigured during zipping such that the strip may be further zipped above an already zipped area.

### Means for Solving the Problem

According to an aspect of the disclosure, a rotary actuator includes a rotor, a stator arranged in a shape of a concentric circle having a rotation axis that is identical to a rotation axis of the rotor, and a strip having an end connected to the rotor and electrostatically zipped along an inner surface of the stator between the rotor and the stator, in which the strip and the stator define a zipping zone between opposing surfaces thereof, the zipping zone including a first electrode, a second electrode, an electroactive polymer film arranged between the first electrode and the second electrode to prevent an electrical short circuit between the first electrode and the second electrode, and a dielectric fluid arranged in at least a part of a space between the first electrode and the second electrode, and in which an electrostatic attractive force is generated between the first electrode and the second electrode upon application of voltages of opposite polarities to the first electrode and the second electrode, the strip performs zipping motion in which the strip progressively adheres to the inner surface of the stator due to the electrostatic attractive force, and a force generated by the zipping motion is transmitted to the rotor such that a rotational force is generated in the rotor.

The strip may include an end wound around the rotor and another end connected to the stator, and as zipping of the strip progresses, the strip may rotate the rotor while being wound onto and adhered to the inner surface of the stator in a winding manner.

A zipping angle formed between the strip and the stator may be maintained constant during the zipping motion.

The strip may be provided as a plurality of strips that are arranged in an electrostatic driving area formed between an outer side of the rotor and an inner side of the stator to each perform electrostatic zipping driving. The plurality of strips may include a first strip and a second strip that are wound around the rotor in different directions, the first strip and the second strip respectively generating rotational motions in different directions to perform bidirectional driving.

At least one of the plurality of strips may be a range of motion (ROM) scaling strip that includes an insulating film, a flexible negative electrode arranged on a front surface of the insulating film, an electroactive polymer film stacked on the flexible negative electrode or including the flexible negative electrode therein, a plurality of electrode segments partitioned and arranged in a zipping direction on a rear surface of the insulating film, and a protruding via electrically connected to each of the plurality of electrode segments and extending through the insulating film to protrude from the front surface.

According to another aspect of the disclosure, a driving method of an electrostatic zipping rotary actuator includes arranging a first electrode, a second electrode, an electroactive polymer film, and a dielectric fluid in a zipping zone between a strip and a stator, the strip arranged between a rotor and the stator, applying voltages of opposite polarities to the first electrode and the second electrode, generating an electrostatic attractive force between the first electrode and the second electrode, progressively adhering the strip to an inner surface of the stator by the electrostatic attractive force, and rotating the rotor by transmitting a force generated by the progressive adhering of the strip to the rotor.

### EFFECTS OF THE INVENTION

A rotary actuator according to an embodiment may progressively adhere a strip to an inner surface of a stator by using an electrostatic attractive force and may convert the zipping motion into rotational motion of a rotor.

By circumferentially arranging a plurality of strips, tensile forces or zipping driving forces generated by the respective strips may be combined, and thus, rotational torque may be scaled up as the number of strips increases.

For a rotary actuator using ROM scaling strips, even an already zipped region may be reconfigured according to an electrical boundary condition for subsequent zipping, and thus, a limitation on a rotational motion range, which occurs in a multi-strip structure, may be alleviated.

The rotational motion range may be designed independently by the length of the strip, the number of electrode segments, the arrangement of protruding vias, the winding structure of the strip, and the like, torque scaling and rotational range scaling may be performed independently of each other.

Because an actuator according to the disclosure uses an electrostatic force, a driving current may be small, and the actuator may be manufactured using a non-magnetic material, thereby allowing the actuator to be used in a high-magnetic-field environment or a magnetic-field-sensitive environment.

### BRIEF DESCRIPTION OF THE DRAWINGS

FIG. 1 shows a basic structure of a rotary actuator using electrostatic zipping and a principle by which zipping motion is converted into rotational motion, according to an embodiment.

FIG. 2 shows a multi-strip electrostatic zipping rotary actuator according to another embodiment.

FIG. 3 shows a bidirectional electrostatic zipping rotary actuator according to another embodiment.

FIG. 4 shows a cross-sectional structure and charge distribution corresponding to a zipping front according to an embodiment.

FIG. 5 shows a multi-strip rotary actuator to which a range of motion (ROM) scaling strip is applied, according to an embodiment.

### DETAILED DESCRIPTION FOR CARRYING OUT THE INVENTION

Hereinafter, the disclosure will be described with reference to the drawings.

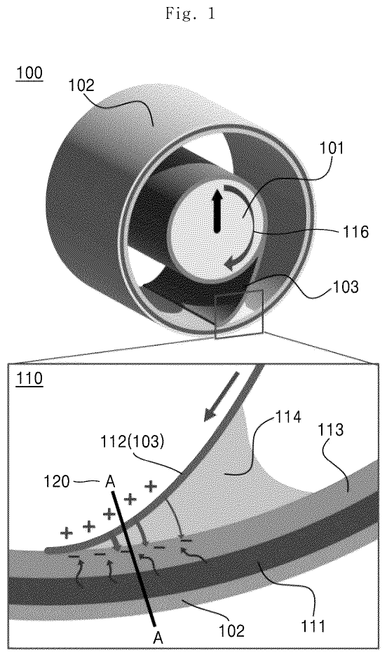

FIG. 1 shows a basic structure of a rotary actuator using electrostatic zipping and a principle by which zipping motion is converted into rotational motion, according to an embodiment.

A rotary actuator 100 may include a rotor 101, a stator 102, and a strip 103.

The rotor 101 may be a member arranged to rotate about a rotational axis, and the stator 102 may be a fixing member that surrounds an outer side of the rotor 101 in the shape of a concentric circle having a rotational axis identical to that of the rotor 101. The strip 103 may be arranged such that an end thereof is connected to or wound around the rotor 101 and another portion thereof is elastically zipped along an inner surface of the stator 102.

The strip 103 may progressively adhere to the inner surface of the stator 102 due to an electrostatic attractive force, and a force generated in this process may be transferred to the rotor 101 to rotate the rotor 101 in an arrow direction 116. The strip 103 may have a certain bending stiffness or tensile stiffness, resulting in a self-restoring force and a negligible stiffness.

A zipping zone 110 may be formed between facing surfaces of the strip 103 and the stator 102. The zipping zone 110 may include a first electrode 111, a second electrode 112, an electroactive polymer film 113, and a dielectric fluid 114.

The first electrode 111 may be arranged on the inner surface of the stator 102. The second electrode 112 may be arranged at a strip 103. On the other hand, the first electrode 111 may be arranged at the strip 103, and the second electrode 112 may be arranged on the stator 102.

A body of the stator 102 or the strip 103 may function as an electrode. In FIG. 1, a structure in which the strip 103 functions as the second electrode 112 is indicated by 112(103). Therefore, in the current embodiment, the strip 103 may serve as both a mechanical force transmission member and an electrode. When voltages of opposite polarities are applied to the first electrode 111 and the second electrode 112, an electrostatic attractive force may be generated between the first and second electrodes 111 and 112.

The electroactive polymer film 113 may be arranged between the first electrode 111 and the second electrode 112 to prevent direct electrical connection between the two electrodes 111 and 112. The electroactive polymer film 113 may be a polymer film such as polyvinyl chloride (PVC)-gel. The PVC-gel may accumulate negative charges on a surface close to a positive electrode under an electric field. Thus, a strong electrostatic attractive force may be generated between the positive electrode and negative charges on a PVC-gel surface, and a zipping force of the strip 103 may increase.

In addition, the electroactive polymer film 113 and the dielectric fluid 114 may form separate layers between the first electrode 111 and the second electrode 112. Two layers may have different electrical time constants, and when current flows, charge may be accumulated at an interface between the two layers. Such charge accumulation may change electric field distribution between electrodes and amplify an electrostatic attractive force between the strip 103 and the stator 102. As a result, greater zipping force and rotational torque may be obtained.

The dielectric fluid 114 may fill the entire space between the first electrode 111 and the second electrode 112 or a part thereof. The dielectric fluid 114 may be insulating oil, silicone oil, dielectric liquid, or gas. The dielectric fluid 114 may serve to maintain insulation between electrodes, reduce friction, control electric field distribution, assist in the deformation of a polymer film, or stabilize zipping. The dielectric fluid 114 may maintain insulation between the electrodes together with the electroactive polymer film 113 and contribute to formation of electric field distribution and interface charge in the zipping zone 110.

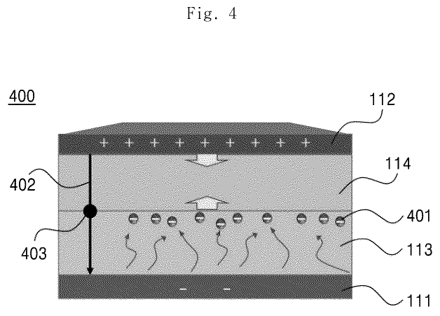

“A” 120 may indicate a zipping front where the strip 103 begins to newly adhere to the inner surface of the stator 102. The zipping front may refer to a boundary area where the strip 103 begins to newly adhere to the inner surface of the stator 102. Upon application of a voltage, charges of opposite polarities may be formed between the first electrode 111 and the second electrode 112, causing an electrostatic attractive force. Using the attractive force, the strip 103 may progressively adhere to the inner surface of the stator 102 with respect to a zipping front A 120. For a cross-sectional structure and charge distribution of the zipping front A 120, a description of FIG. 4 will be referred to.

In FIG. 1, a ‘+’ sign may indicate charge on a positive electrode side, and charge on an opposite side may indicate charge of an opposite polarity formed on the electroactive polymer film 113 or a first electrode 111 side. Due to the attractive force between charges of opposite polarities, the strip 103 may be pulled toward the stator 102, and the zipping front A may move in a circumferential direction. In other words, in the rotary actuator 100, the strip 103 may not adhere to the stator 102 all at once, but in such a way that an adhered area of the strip 103 is sequentially expanded as the zipping front A moves. In other words, as the zipping motion proceeds, a tensile force in a longitudinal direction may be generated in the strip 103. As an end of the strip 103 is connected to the rotor 101, the tensile force generated in the strip 103 may be transmitted to the rotor 101 that may then rotate around the rotation axis. Thus, the electrostatic zipping motion may be converted into rotational torque. Accordingly, the rotary actuator 100 may generate the rotational force using an electrostatic attractive force without separate electromagnetic coils or magnetic materials.

In an embodiment, a zipping angle formed by the strip 103 and the stator 102 may be maintained constant during zipping. Here, the zipping angle may refer to an angle formed between a unadhered area of the strip 103 and the inner surface or a tangential direction of the stator 102 near the zipping front. When the zipping angle is maintained constant, a driving force generated in the zipping front may be maintained stable. Consequently, a change in the rotational force transmitted to the rotor 101 may decrease and rotary driving may be performed stably.

In another embodiment, the zipping angle may change may change according to stiffness, thickness, curvature, and voltage of the strip 103, viscosity of dielectric fluid, elasticity of the electroactive polymer film, rotor radius, and stator radius.

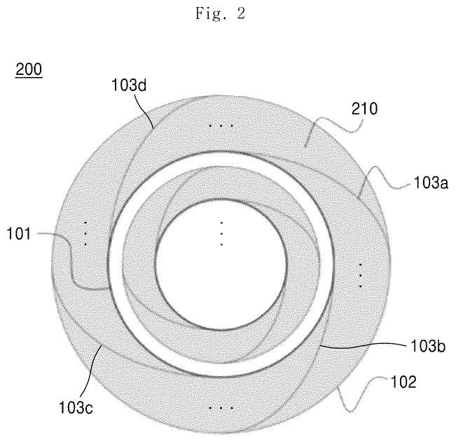

FIG. 2 shows a multi-strip electrostatic zipping rotary actuator according to another embodiment. The rotary actuator 200 shown in FIG. 2 may include a plurality of strips 103 to amplify a driving force in the form of multi-strips, unlike in FIG. 1.

The rotary actuator 200 may include the rotor 101, the stator 102, a plurality of strips 103a, 103b, 103c, and 103d, and an electrostatic driving area 210. The plurality of strips 103a, 103b, 103c, and 103d may be arranged in the circumferential direction of the rotor 101.

In a single-strip structure as shown in FIG. 1, a force generated during zipping of the strip 103 may be transmitted to the rotor 101, but in the multi-strip structure as shown in FIG. 2, each of the plurality of strips 103a, 103b, 103c, and 103d may perform electrostatic zipping motion.

Each strip 103a, 103b, 103c, or 103d may generate a tensile force independently, and all of the tensile forces may be transmitted to the rotor 101. Therefore, ideally, as the number of strips increases, the rotational force transmitted to the rotor 101 may also increase. For example, when n strips having the same structure and the same driving conditions are arranged, zipping driving forces of the respective strip may be combined to obtain increased rotational torque compared to a single strip.

However, in the multi-strip structure of FIG. 2, when the plurality of strips 103a, 103b, 103c, and 103d are arranged along the inner surface of the stator 102 in the circumferential direction, a circumferential zipping area that may be used by each strip 103a, 103b, 103c, or 103d may be limited. That is, as the number of strips increases, a circumferential zipping angle allocated to each strip may decrease. For example, when n strips are arranged in the circumferential direction, a circumferential angle through which each strip is zipped may be limited to about 2TT/n.

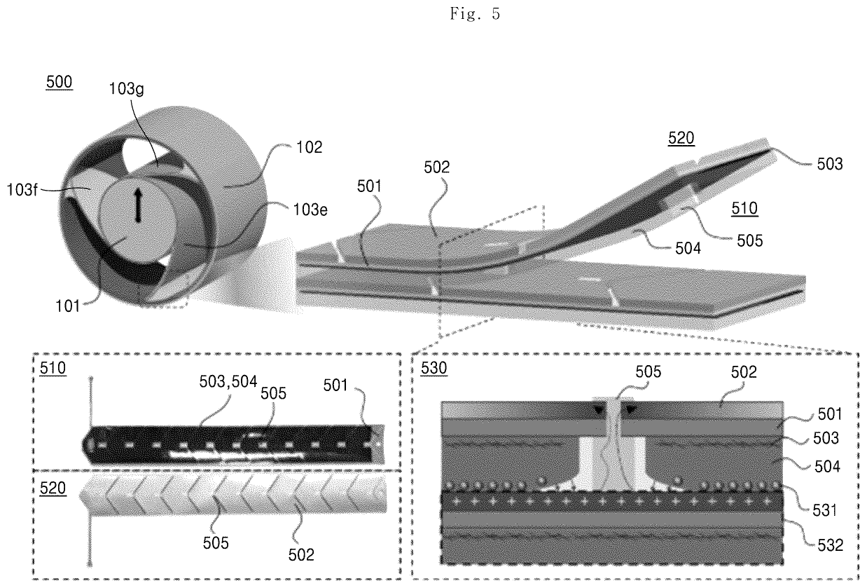

Thus, in the multi-strip structure shown in FIG. 2, a rotational force may increase by increasing the number of strips, but a range of rotational motion of each strip may be reduced due to structural constraints. To solve such constraints, a range of motion (ROM) scaling strip may be proposed in FIG. 5. The ROM scaling strip may allow another strip to be zipped over an already zipped strip, thereby alleviating a circumferential zipping angle limitation that may occur in a multi-strip structure as shown in FIG. 2.

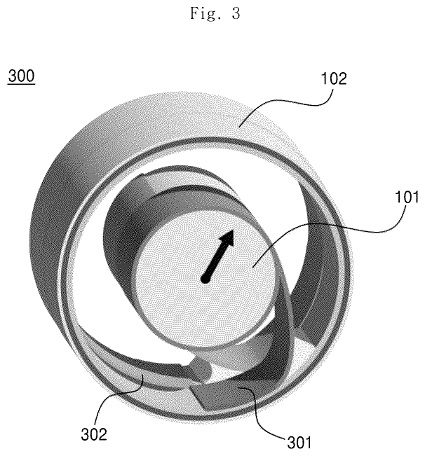

FIG. 3 shows a bidirectional electrostatic zipping rotary actuator according to another embodiment.

A rotary actuator 300 of FIG. 3 may be configured to rotate the rotor 101 bidirectionally by using a plurality of strips 301 and 302 wound around the rotor 101 in different directions.

The rotary actuator 300 may include the rotor 101, the stator 102, the first strip 301, and the second strip 302. The rotor 101 may be a member capable of rotating about the rotational axis, and the stator 102 may be arranged on an outer side of the rotor 101. The rotor 101 and the stator 102 may be arranged in a concentric shape having the same rotational axis. The first strip 301 and the second strip 302 may be arranged in a space between the rotor 101 and the stator 102.

Both strips 301 and 302 may progressively adhere to the inner surface of the stator 102 by electrostatic zipping. However, the first strip 301 and the second strip 302 may differ in that they are wound around the rotor 101 in opposite directions.

In other words, the first strip 301 may be wound to rotate the rotor 101 in one direction, and the second strip 302 may be wound to rotate the rotor 101 in the opposite direction. Thus, when a voltage is applied to the first strip 301 to zip the first strip 301 along the inner surface of the stator 102, a tensile force generated in the first strip 301 may be transmitted to the rotor 101 such that the rotor 101 may rotate in a first rotational direction.

On the other hand, when a voltage is applied to the second strip 302 to zip the first strip 301 along the inner surface of the stator 102, a tensile force generated in the second strip 302 may be transmitted to the rotor 101 in the opposite direction such that the rotor 101 may rotate in a second rotational direction.

In FIG. 3, each of the first strip 301 and the second strip 302 may be regarded as an example of the strip 103. Each of the strips 301 and 302 may form a zipping zone with the stator 102 as described with reference to FIG. 1.

In each zipping zone, a first electrode, a second electrode, an electroactive polymer film, and a dielectric fluid may be arranged. Upon application of a voltage, an electrostatic force may be generated between the first electrode and the second electrode, and a corresponding strip may progressively adhere to the inner surface of the stator 102.

As the first strip 301 and the second strip 302 are wound around the rotor 101 in opposite directions, a tensile force generated by the same zipping principle may be converted into rotational torques in opposite directions. Thus, a rotational direction of the rotor 101 may be selected depending on which strip is driven.

FIG. 4 shows a cross-sectional structure and charge distribution corresponding to a zipping front A 120 according to an embodiment. When the electroactive polymer film 113 is a PVC-gel, negative charges may be accumulated on the surface of the electroactive polymer film 113 near the second electrode 112 that is a positive electrode like charges 401 of FIG. 4. As the negative charges 401 form a charge pair of opposite polarities at a position closer to the second electrode 112 that is a positive electrode, the negative charges 401 may amplify an electrostatic attractive force between the first electrode 111 and the second electrode 112.

In FIG. 4, the dielectric fluid 114 may fill a space between the second electrode 112 and the electroactive polymer film 113. The dielectric fluid 114 may act as a medium that forms an electric field distribution while maintaining electrical insulation between the first and second electrodes. 111 and 112. In addition, the dielectric fluid 114 may form a distinct layer from the electroactive polymer film 113. In FIG. 4, reference number 402 may represent a flow of current or movement of charges that occurs between electrodes or near an interface therebetween when an electric field is applied. Reference numeral 403 may indicate an interface between the dielectric fluid 114 and the electroactive polymer film 113.

The electroactive polymer film 113 and the dielectric fluid 114 may have different electrical time constants or dielectric properties. Therefore, when there is a current flow 402, charges may be accumulated at the interface 403 between two layers. This phenomenon may be described as the Maxwell-Wagner effect and changes electric field distribution within the zipping zone, thereby increasing or stabilizing an electrostatic attractive force.

FIG. 5 shows a multi-strip rotary actuator to which an ROM scaling strip is applied, according to an embodiment.

Referring to FIG. 5, a multi-strip rotary actuator 500 applying ROM scaling strips may include the rotor 101, the stator 102, and a plurality of strips 103e, 103f, and 103g. The rotor 101 may be arranged at a center thereof, and the stator 102 may be arranged concentrically on an outer side of the rotor 101. The plurality of strips 103e, 103f, and 103g are arranged between the rotor 101 and the stator 102, perform electrostatic zipping motion upon application of a voltage, and transmit a rotational force to the rotor 101.

To mitigate a circumferential zipping angle limitation that may occur in a general multi-strip structure, the rotary actuator 500 according to the current embodiment may include each strip 103e, 103f, or 103g as an ROM-scaling strip. In a typical multi-strip structure, when the single strip is first zipped onto the inner surface of the stator, the adhered area may not readily function as an effective electrode surface through which a subsequent strip may be zipped. This is because an already zipped strip covers the electrode surface of the stator or the electroactive polymer surface.

Consequently, even when the subsequent strip approaches, a surface facing the subsequent strip may become the outer surface of the already-zipped strip rather than the surface of the stator electrode. When the outer surface fails to provide an electric potential of a polarity opposite to that of the subsequent strip, a sufficient electrostatic attractive force may not be formed between the subsequent strip and the already-zipped strip. As a result, in a general multi-strip structure, an allowable zipping range of each strip may be limited by a circumferential division area of the stator.

On the other hand, the ROM scaling strips 103e, 103f, and 103g according to the current embodiment may be such that a rear surface of the already-zipped strip functions as a new electrode surface for the subsequent strip. Thus, even after one strip is zipped, a rear electrode segment of the strip may act as an intermediate electrode surface that induces the zipping of the subsequent strip.

ROM scaling strips 510 and 520 each may include an insulating film 501, an electrode segment 502, a flexible negative electrode 503, an electroactive polymer film 504, and a protruding via 505.

The insulating film 501 may serve as a core substrate of the strip, and may electrically separate a front surface 510 and a rear surface 520 of the ROM scaling strip from each other. The insulating film 501 may be formed as a polymer film, an insulating plastic film, a flexible insulating substrate, or an equivalent insulating member.

The flexible negative electrode 503 and the electroactive polymer film 504 may be arranged on the front surface 510 of the ROM scaling strip. The flexible negative electrode 503 may include a carbon nanotube (CNT), but is not limited thereto, and may be formed to include a conductive polymer, a carbon-based electrode, conductive ink, graphene, or a flexible conductive layer. The flexible negative electrode 503 may be embedded within the electroactive polymer film 504 or disposed between the insulating film 501 and the electroactive polymer film 504.

A plurality of electrode segments 502 may be arranged on the rear surface 520 of the ROM scaling strip. The plurality of electrode segments 502 may be partitioned and arranged in the longitudinal direction or zipping direction of the strips on the rear surface of the insulating film 501. Each electrode segment 502 may be separated from the others for electrical insulation, and in an embodiment, may be formed as a copper electrode.

Each electrode segment 502 may be electrically connected to the protruding via 505 that penetrates the insulating film 501. The protruding via 505 may protrude toward the front surface 510 of the ROM scaling strip and may protrude above the surface of the electroactive polymer film 504. The electroactive polymer film 504 and the flexible negative electrode 503 may be arranged to maintain a certain distance from the protruding via 505 and thus may not be electrically connected to the protruding via 505.

Thus, the protruding via 505 may be electrically connected to the electrode segments 502 of the rear surface, but may be electrically insulated from the flexible negative electrode 503 and the electroactive polymer film 504 of the front surface. Due to this structure, a negative electrode structure formed on the front surface 510 of the ROM scaling strip and the electrode segments 502 formed on the rear surface 520 may function independently of one another.

Referring to a cross-sectional view 530 of the zipping zone in FIG. 5, negative charges 531 may be induced on the surface of the electroactive polymer film 504 due to the flexible negative electrode 503 and the electroactive polymer film 504 on the front surface 510 of the ROM scaling strip when voltage is applied. In this case, the inner surface of the stator 102 or the rear electrode segments 502 of another already-zipped strip may function as a positive electrode surface 532.

Due to an electrostatic attractive force formed between the negative charges 531 of the electroactive polymer film 504 and the positive electrode surface 532, the strip may be absorbed toward the positive electrode surface 532 and zipping may be performed from a contact start point. As zipping progresses, the protruding via 505 protruding beyond the surface of the electroactive polymer film 504 may preferentially contact the positive electrode surface 532.

When the protruding via 505 contacts the positive electrode surface 532, the rear electrode segments 502, connected to the protruding via 505, may be positively charged in a floating state. The rear electrode segments 502 charged in this way may form a new electrical boundary condition for another strip subsequently approaching or a subsequent portion of the same strip. Thus, an already zipped area may function as a positive electrode surface capable of inducing subsequent zipping rather than as an inactive area simply covering a counter electrode surface.

For example, the first strip 103e may first be zipped and adhered to the inner surface of the stator 102 or to the positive electrode surface electrically connected to the stator 102. While the first strip 103e is zipped, the protruding via 505 of the first strip 103e may contact the positive electrode surface of the stator 102, such that the rear electrode segments 502 of the first strip 103e may be positively charged through the protruding via 505.

At this point, as the rear electrode segments 502 of the first strip 103e are electrically insulated from the flexible negative electrode 503 and the electroactive polymer film 504 arranged on the front surface of the first strip 103e, they may function as an electrode surface having a positive electric potential, independently of a front electrode structure.

Thereafter, when the second strip 103f approaches the first strip 103e from above, negative charges may be induced on the surface of the electroactive polymer film 504 of the second strip 103f. An electrostatic attractive force may arise between the negative charges of the second strip 103f and the positive electrode surface formed by the rear electrode segments 502 of the first strip 103e such that the second strip 103f may be zipped above the first strip 103e.

In a process in which the second strip 103f is zipped above the first strip 103e, the protruding via 505 of the second strip 103f may contact the positively charged rear electrode segments 502 of the first strip 103e. In this case, the rear electrode segments 502 of the second strip 103f may also be positively charged through the protruding via 505. As a result, the rear electrode segments 502 of the second strip 103f may function as the third strip 103g subsequently approaching or another intermediate electrode surface for another subsequent portion.

Such an action may be repeated even when a plurality of strips are sequentially zipped in several layers. Thus, a first zipped strip may function as an electrode surface inducing zipping of a subsequent strip, rather than as a cover that interferes with zipping of the subsequent strip.

By using such an ROM scaling strip, in a multi-strip structure, an allowable zipping range of each strip may not be limited simply by a circumferential division angle of the inner surface of the stator. In a general multi-strip structure, when n strips are arranged, a maximum zipping angle of each strip may be limited to about 2π/n. However, in the current embodiment, the rear electrode segments of the first zipped strip may function as the positive electrode surface for subsequent zipping, the subsequent strip may be zipped above the already-zipped strip.

Thus, the allowable zipping range of each strip may be adjusted by a length of the ROM scaling strip without depending on solely the circumferential division angle determined by the number of multiple strips. As a result, a rotational torque may be amplified by increasing the number of strips, and the rotational motion range may be expanded by adjusting the length of strips.

That is, according to the current embodiment, a multi-strip rotary actuator may be provided which is capable of designing torque scaling and rotational motion range scaling independently of each other.

### DESCRIPTION OF REFERENCE NUMERALS

100: Rotary Actuator
101: Rotor
102: Stator
103: Strip
110: Zipping Zone
111: First Electrode
112: Second Electrode
113: Electroactive Polymer Film
114: Dielectric Fluid
200: Rotary Actuator
210: Electrostatic Driving Area
300: Rotary Actuator
301: First Strip
302: Second Strip
400: Zipping Zone Cross-sectional Structure
401: Charges on Surface of Electroactive Polymer Film
402: Current Flow or Charge Movement
403: Interface between Dielectric Fluid and Electroactive Polymer Film
500: Rotary Actuator Having Range of Motion Scaling Strip Applied thereto
501: Insulating Film
502: Electrode Segment
503: Flexible Negative Electrode
504: Electroactive Polymer Film
505: Protruding Via
510: Front Surface
520: Rear Surface
530: Zipping Interface Cross-section
531: Negative Charges on Surface of Electroactive Polymer Film
532: Positive Electrode Surface

1. A rotary actuator comprising:
a rotor;
a stator arranged in a shape of a concentric circle having a rotation axis that is identical to a rotation axis of the rotor; and
a strip having an end connected to the rotor and electrostatically zipped along an inner surface of the stator between the rotor and the stator,
wherein the strip and the stator define a zipping zone between opposing surfaces thereof, the zipping zone comprising:
a first electrode;
a second electrode;
an electroactive polymer film arranged between the first electrode and the second electrode to prevent an electrical short circuit between the first electrode and the second electrode; and
a dielectric fluid arranged in at least a part of a space between the first electrode and the second electrode,
and wherein an electrostatic attractive force is generated between the first electrode and the second electrode upon application of voltages of opposite polarities to the first electrode and the second electrode, the strip performs zipping motion in which the strip progressively adheres to the inner surface of the stator due to the electrostatic attractive force, and a force generated by the zipping motion is transmitted to the rotor such that a rotational force is generated in the rotor.

2. The rotary actuator of claim 1, wherein the strip comprises an end wound around the rotor and another end connected to the stator, and as zipping of the strip progresses, the strip rotates the rotor while being wound onto and adhered to the inner surface of the stator in a winding manner.

3. The rotary actuator of claim 1, wherein a zipping angle formed between the strip and the stator is maintained constant during the zipping motion.

4. The rotary actuator of claim 1, wherein the strip is provided as a plurality of strips that are arranged in an electrostatic driving area formed between an outer side of the rotor and an inner side of the stator to each perform electrostatic zipping driving.

5. The rotary actuator of claim 4, wherein the plurality of strips comprise a first strip and a second strip that are wound around the rotor in different directions, the first strip and the second strip respectively generating rotational motions in different directions to perform bidirectional driving.

6. The rotary actuator of claim 4, wherein the electrostatic driving area is provided as a plurality of electrostatic driving areas that are stacked concentrically to amplify a rotational force transmitted to the rotor.

7. The rotary actuator of claim 4, wherein at least one of the plurality of strips is a range of motion (ROM) scaling strip that comprises:
an insulating film;
a flexible negative electrode arranged on a front surface of the insulating film;
an electroactive polymer film stacked on the flexible negative electrode or comprising the flexible negative electrode therein;
a plurality of electrode segments partitioned and arranged in a zipping direction on a rear surface of the insulating film; and
a protruding via electrically connected to each of the plurality of electrode segments and extending through the insulating film to protrude from the front surface.

8. The rotary actuator of claim 7, wherein the protruding via protrudes above the electroactive polymer film, and the electroactive polymer film and the flexible negative electrode are kept spaced apart from the protruding via with a gap therebetween so as not to be electrically connected to the protruding via.

9. The rotary actuator of claim 7, wherein an electrode segment connected to the protruding via is sequentially charged positively in a longitudinal direction of the ROM scaling strip such that the ROM scaling strip or another strip is zippable over a previously zipped strip, and
a rotational motion range of the rotor is adjusted by a length of the ROM scaling strip rather than a circumferential zipping angle of each strip limited by a number of the plurality of strips.

10. The rotary actuator of claim 1, wherein the electroactive polymer film and the dielectric fluid form respective layers between the first electrode and the second electrode, and have different electrical time constants such that charges accumulate at an interface between the electroactive polymer film and the dielectric fluid when a current flows.

11. A driving method of an electrostatic zipping rotary actuator comprising:
arranging a first electrode, a second electrode, an electroactive polymer film, and a dielectric fluid in a zipping zone between a strip and a stator, the strip arranged between a rotor and the stator;
applying voltages of opposite polarities to the first electrode and the second electrode;
generating an electrostatic attractive force between the first electrode and the second electrode;
progressively adhering the strip to an inner surface of the stator by the electrostatic attractive force; and
rotating the rotor by transmitting a force generated by the progressive adhering of the strip to the rotor.

12. The driving method of claim 11, wherein the progressively adhering of the strip comprises:
moving a zipping front in a circumferential direction from a contact start point between the strip and the stator.

13. The driving method of claim 11, wherein the strip is provided as a plurality of strips and the driving method further comprises
zipping the plurality of strips along the inner surface of the stator by applying a voltage to each of the plurality of strips, and combining and transmitting forces generated by the plurality of strips to the rotor to increase rotational torque.

14. The driving method of claim 13, further comprising controlling a rotational direction of the rotor by selectively driving one of a first direction strip wound in a first rotational direction and a second direction strip wound in a second rotational direction.

15. The driving method of claim 13, wherein at least one of the plurality of strips is a range of motion (ROM) scaling strip comprising an insulating layer, a front electrode layer, an electroactive polymer layer, a plurality of rear electrode segments, and a protruding via and
the driving method further comprises:
bringing the protruding via into contact with the inner surface of the stator or an electrode surface of an already zipped strip during zipping;
sequentially charging the plurality of rear electrode segments through the protruding via; and
using the sequentially charged plurality of rear electrode segments as an electrode surface for subsequent zipping.
